(19) United States
(12) Patent Application Publication
(10) Pub. No.: US 2023/0217353 A1
(43) Pub. Date: Jul. 6, 2023

(54) TUNNEL NEIGHBOR DISCOVERY

(71) Applicant: Hewlett Packard Enterprise Development LP, Houston, TX (US)

(72) Inventors: Goldy Tomy, Roseville, CA (US); Luis A. Mora, Roseville, CA (US)

(21) Appl. No.: 17/568,609

(22) Filed: Jan. 4, 2022

(51) Int. Cl. H04W 48/16; H04W 28/02; H04W 72/04; H04W 48/04

(52) U.S. Cl. CPC H04W 48/16; H04W 28/0215; H04W 72/048; H04W 48/04

(57) ABSTRACT

A system for discovering tunnel neighbors is provided. During operation, the system can establish, at a first switch, a tunnel with a second switch in an overlay tunnel fabric that includes the first and second switches. Upon establishing the tunnel, the system can generate a discovery packet comprising a first set of discovery information indicating the configuration and capabilities of the first switch associated with the tunnel. The system can send the discovery packet to the second switch via the tunnel prior to initiating payload data communication via the tunnel. The system can also receive a second discovery packet from the second switch via the tunnel. The second discovery packet can include a second set of discovery information indicating the configuration and capabilities of the second switch associated with the tunnel. The system can then store the second set of discovery information in an entry of a data structure.

### BACKGROUND

### Field

The present disclosure relates to communication networks. More specifically, the present disclosure relates to a method and system for discovering tunnel neighbors.

### BRIEF DESCRIPTION OF THE FIGURES

FIG. 1 illustrates an example of tunnel neighbor discovery in a network, in accordance with an aspect of the present application.

FIG. 2A illustrates an example of a discovery packet for facilitating tunnel neighbor discovery, in accordance with an aspect of the present application.

FIG. 2B illustrates examples of pieces of discovery information shared for tunnel neighbor discovery, in accordance with an aspect of the present application.

FIG. 3A illustrates an example of determining configuration consistency based on tunnel neighbor discovery, in accordance with an aspect of the present application.

FIG. 3B illustrates an example of determining the capabilities of a tunnel neighbor, in accordance with an aspect of the present application.

FIG. 4 presents a flowchart illustrating the process of a tunnel endpoint issuing a tunnel neighbor discovery packet, in accordance with an aspect of the present application.

FIG. 5 presents a flowchart illustrating the process of a tunnel endpoint processing a tunnel neighbor discovery packet, in accordance with an aspect of the present application.

FIG. 6 illustrates an example of a switch with tunnel neighbor discovery support, in accordance with an aspect of the present application.

In the figures, like reference numerals refer to the same figure elements.

### DETAILED DESCRIPTION

The following description is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the aspects shown, but is to be accorded the widest scope consistent with the claims.

Internet is the delivery medium for a variety of applications running on physical and virtual devices. Such applications have brought with them an increasing traffic demand. As a result, equipment vendors race to build switches with versatile capabilities. To do so, a switch may support different protocols and services. For example, the switch can support tunneling and virtual private networks (VPNs). The switch can then facilitate overlay routing for a VPN over the tunnels. For example, an Ethernet VPN (EVPN) can be deployed as an overlay over a set of virtual extensible local area networks (VXLANs). To deploy a VPN over the tunnels, a respective tunnel endpoint may map a respective client virtual local area network (VLAN) to a corresponding virtual network identifier (VNI), which can identify a virtual network for a tunnel.

The VNI may appear in a tunnel header that encapsulates a packet and is used for forwarding the encapsulated packet via a tunnel. For example, if the tunnel is formed based on VXLAN, there can be a VNI in the VXLAN header, and a tunnel endpoint can be a VXLAN tunnel endpoint (VTEP). A VNI can also be mapped to the virtual routing and forwarding (VRF) associated with the tunnels if the layer-3 routing and forwarding are needed. Since a VPN can be distributed across the tunnel fabric, a VPN over the tunnel fabric can also be referred to as a distributed tunnel fabric. A gateway of the fabric can be a virtual gateway switch (VGS) shared among a plurality of participating switches.

Typically, device pairs with a link between them are referred to as neighbors. Such neighbors can be discovered by Link Layer Discovery Protocol (LLDP). On the other hand, tunnel endpoint pairs with a tunnel between them (e.g., VTEPs of a VXLAN tunnel) can be referred to as tunnel neighbors. Hence, the neighbors in a distributed tunnel fabric can be tunnel neighbors. Since the tunnel may span multiple links and network domains, tunnel neighbors may belong to different networks, administrative domains, and/or geographic location. As a result, link-based neighbor discovery protocols, such as LLDP, cannot discover tunnel neighbors.

One aspect of the present technology can provide a system for discovering tunnel neighbors. During operation, the system can establish, at a first switch, a tunnel with a second switch in an overlay tunnel fabric that includes the first and second switches. The encapsulation of a packet sent via the tunnel is initiated and terminated between the first and second switches. Upon establishing the tunnel, the system can generate, at the first switch, a discovery packet comprising a first set of discovery information indicating the configuration and capabilities of the first switch associated with the tunnel. The system can send the discovery packet to the second switch via the tunnel prior to initiating payload data communication via the tunnel. The system can also receive a second discovery packet from the second switch via the tunnel. The second discovery packet can include a second set of discovery information indicating the configuration and capabilities of the second switch associated with the tunnel. The system can then store the second set of discovery information in an entry of a data structure. A respective entry of the data structure comprises information associated with a remote tunnel endpoint of the overlay tunnel fabric.

In a variation on this aspect, a respective piece of discovery information in the first set of discovery information is encoded as a type-length-value (TLV) field in the first discovery packet.

In a further variation, a respective discovery packet includes respective TLV fields for a system name, a source address of the tunnel, and an end of packet indicator.

In a further variation, a respective discovery packet further includes respective TLV fields for one or more of: a provisioning source of the tunnel, a source interface of the tunnel, and a management address of a source of the discovery packet, a first set of information associated with a layer-2 virtual network identifier (VNI) configured for the tunnel, and a second set of information associated with a layer-3 VNI configured for the tunnel.

In a variation on this aspect, the system can select a subset of optional discovery information associated with the first switch for incorporating into the first set of discovery information.

In a variation on this aspect, the system can determine that the second discovery packet is for tunnel neighbor discovery based on a packet type of the second discovery packet.

In a variation on this aspect, the system can determine configuration consistency for the tunnel based on the first and second sets of discovery information.

In a variation on this aspect, the system can determine the capability of the second switch based on the second set of discovery information. The capability includes capacities and supported features of the second switch.

In a further variation, the system can determine whether the second switch is inefficiently provisioned by comparing respective capabilities of the first and second switches.

The aspects described herein solve the problem of automatically discovering information associated with a tunnel neighbor by (i) sending a discovery packet with local discovery information to a remote tunnel endpoint via a tunnel; and (ii) storing, in a local data structure, discovery information from a discovery packet received from the remote tunnel endpoint via the tunnel. In this way, the exchange of discovery packets allows a tunnel endpoint to discover information, such as capacities and capabilities, of a respective remote tunnel endpoint. The endpoints can then use the discovery information to provide enhancement services, such as endpoint consistency and capacity subscription.

With existing technologies, a link discovery protocol, such as LLDP, may provide discovery functionality for link neighbors. However, the link discovery protocol may facilitate the discovery of a limited set of information (e.g., using corresponding type-length-values (TLV) encoding fields). Furthermore, the link discovery protocol may only support the discovery of link neighbors coupled via a network link. On the other hand, a distributed tunnel fabric can be deployed over a large and complex multi-site network, and may involve VPNs and overlay tunneling (e.g., VxLAN-EVPN). Hence, the link discovery protocol may not be usable for tunnel neighbor discovery in the fabric. As a result, determining how the logical network topology is formed in the fabric and the capabilities of tunnel neighbors can become challenging.

To solve this problem, an instance of a tunnel neighbor discovery protocol (TNDP) can be deployed on the switches in the fabric. The TNDP instance facilitates a method of exchanging device-specific discovery information between tunnel neighbors (i.e., the neighboring switches in the logical network topology of the fabric) coupled through corresponding overlay tunnels. The discovery information can include, but is not limited to, system-level settings, identifying information, hardware resource usage, configured routing protocols, management information, and layer-3 reachability information. By obtaining discovery information from a respective tunnel neighbor, a switch in the fabric can generate a representation of the logical network of the fabric and its capabilities. The switch may then facilitate one or more enhancement services that can ensure configuration consistency and efficiency among the devices of the fabric.

During operation, upon detecting that a tunnel to a peer switch is operational, the TNDP instance of a switch can send a discovery packet to the peer switch. Similarly, the TNDP instance of the switch can receive a discovery packet from the peer switch. The peer switch can be a remote tunnel endpoint of a tunnel originating at the switch. In other words, the switch and the peer switch can be the endpoints of a tunnel. The discovery packet can include a set of discovery information associated with the local device. The set of discovery information can include a set of mandatory information and a set of optional information. A respective piece of discovery information can be incorporated into the discovery packet based on TLV encoding. Upon receiving the discovery packet from the peer switch, the switch can parse a respective TLV field of the packet and obtain the information encoded in the TLV field.

The switch can then store the obtained information in association with an identifier of the peer switch in a discovery table. In this way, the switch can obtain discovery information from a respective peer switch from a corresponding tunnel. Since a respective switch of the fabric can obtain switch-specific information from a respective peer switch, the switch can discover the tunnel neighbors of the fabric. The switch may perform one or more enhancement operations, such as ensuring consistency and efficient provisioning, based on the discovery information. Furthermore, the switch can provide the information from the discovery table to a user (e.g., an administrator) via a local configuration interface of the switch or an external management tool through a communication channel. The user or the management tool can then perform the enhancement operations.

The set of mandatory discovery information can include one or more of: a system name (or hostname) associated with the switch, an identifier of the switch (e.g., a source Internet Protocol (IP) address allocated to the switch), and an indicator indicating the end of the discovery packet. Furthermore, the set of optional discovery information can include one or more of: forwarding profile, operational mode, interface tunnel description, tunnel provisioning source (e.g., static tunnels, control plane, or both), the overlay protocol for the fabric (e.g., external Border Gateway Protocol (eBGP), internal BGP (iBGP), etc.), configured layer-2 VNIs, configured layer-3 VNIs, Address Resolution Protocol (ARP) configuration (e.g., suppression enabled/disabled), host routes, management IP address, tunnel bridging mode enabled/disabled, respective counts of MAC addresses, ARP table entries, and routes, upstream connectivity information (e.g., multi-chassis link aggregation (MLAG) or routed only port (ROP)), multicast bridging/routing enabled/disabled, spanning tree enabled/disabled, and the access port count.

In this disclosure, the term “switch” is used in a generic sense, and it can refer to any standalone or fabric switch operating in any network layer. “Switch” should not be interpreted as limiting examples of the present invention to layer-2 networks. Any device that can forward traffic to an external device or another switch can be referred to as a “switch.” Any physical or virtual device (e.g., a virtual machine or switch operating on a computing device) that can forward traffic to an end device can be referred to as a “switch.” Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to layer-3 networks. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

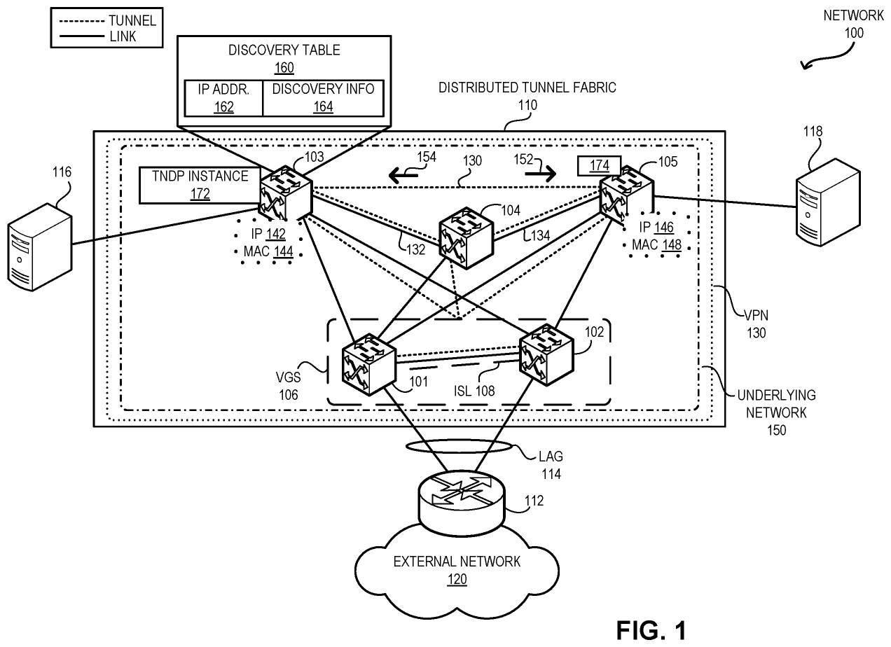

FIG. 1 illustrates an example of tunnel neighbor discovery in a network, in accordance with an aspect of the present application. A network 100 can include a number of switches and devices, and may include heterogeneous network components, such as layer-2 and layer-3 hops, and tunnels. In some examples, network 100 can be an Ethernet, InfiniBand, or other networks, and may use a corresponding communication protocol, such as Internet Protocol (IP), FibreChannel over Ethernet (FCoE), or other protocol. Network 100 can include a distributed tunnel fabric 110 comprising switches 101, 102, 103, 104, and 105, each of which can be associated with a MAC address and an IP address. For example, switch 103 can be associated with an IP address 142 and a MAC address 144. Similarly, switch 105 can be associated with an IP address 146 and a MAC address 148.

In FIG. 1, a respective link denoted with a dotted line in fabric 110 can be a tunnel. Switches of fabric 110 may form a mesh of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec). A respective link denoted with a solid line in fabric 110 can be a link in an underlying network (or an underlay network) 150 of fabric 110. Underlying network 150 can be a physical network, and a respective link of underlying network 150 can be a physical link. A VPN 130, such as an Ethernet VPN (EVPN), can be deployed over fabric 110. Fabric 110 can include a virtual gateway switch (VGS) 106 that can be coupled to an external switch 112 via a LAG 114. Here, LAG 114 can be an MLAG and present the links between VGS 106 and switch 112 as an aggregated link.

VGS 106 can couple fabric 110 to an external network 120 via external switch 112. Here, switches 101 and 102 can operate as a single switch in conjunction with each other to facilitate VGS 106. VGS 106 can be associated with one or more virtual addresses (e.g., a virtual IP address and/or a virtual MAC address). A respective tunnel formed at VGS 106 can use the virtual address to form the tunnel endpoint. To efficiently manage data forwarding, switches 101 and 102 can maintain an inter-switch link (ISL) 108 between them for sharing control and/or data packets. ISL 108 can be a layer-2 or layer-3 connection that allows data forwarding between switches 101 and 102. ISL 108 can also be based on a tunnel between switches 101 and 102 (e.g., a VXLAN tunnel).

Because the virtual address of VGS 106 is associated with both switches 101 and 102, other tunnel endpoints, such as switches 103, 104, and 105, of fabric 110 can consider VGS 106 as the other tunnel endpoint for a tunnel instead of switches 101 and 102. To forward traffic toward VGS 106 in fabric 110, a remote switch, such as switch 103, can operate as a tunnel endpoint while VGS 106 can be the other tunnel endpoint. From each of switches 103, 104, and 105, there can be a set of paths (e.g., equal-cost multiple paths or ECMP) to VGS 106. A respective path in underlying network 150 can lead to one of the participating switches of VGS 106. Hosts (or end devices) 116 and 118 can be coupled to switches 103 and 105, respectively.

With existing technologies, a link discovery protocol, such as LLDP, may provide discovery functionality for link neighbors. In network 100, switches 103 and 105 are coupled to switch 104 via links 132 and 134, respectively. Hence, switches 103 and 105 can be link neighbors of switch 104. The link discovery protocol may facilitate the discovery of a limited set of information and only support the discovery of link neighbors coupled via a network link. As a result, switch 104 may discover a limited set of information about switches 103 and 105. However, fabric 110 can be deployed over a large and complex multi-site network and facilitate VPN 130. Hence, the link discovery protocol may not be usable for tunnel neighbor discovery in fabric 110. For example, switches 103 and 105 can be tunnel neighbors and cannot be discovered by the link discovery protocol. As a result, determining how logical network topology in fabric 110 and the capabilities of tunnel neighbors can become challenging.

A neighbor discovery protocol for VPN 130 may securely discover layer-2 neighbors spanned across a layer-3 network. However, such the neighbor discovery protocol is not configured for discovering tunnel endpoints. Therefore, if a tunnel is established without configuring a VPN, the neighbor discovery protocol may not facilitate the discovery of neighbors. Furthermore, tunnel multicast can be used for discovering and learning about endpoints in a network. A tunnel endpoint may advertise its local information within the same tunnel segment (e.g., for the same VNI) based on the tunnel-based multicast. However, these solutions do not facilitate discovering tunnel neighbors without additional deployment of a virtual network.

To solve this problem, an instance of TNDP can be deployed on one or more switches in fabric 110. For example, TNDP instances 172 and 174 can be deployed on switches 103 and 105, respectively. TNDP instance 172 can facilitate a method of exchanging device-specific discovery information from tunnel neighbor 105 (i.e., a peer switch) coupled through corresponding overlay tunnel 130. The discovery information can include, but is not limited to, system-level settings of switch 105, identifying information (e.g., addresses 146 and 148), hardware resource usage at switch 105, routing protocols in switch 105, management information for switch 105, and layer-3 reachability information associated with switch 105. By obtaining discovery information from switch 105, switch 103 can generate a representation of the logical connectivity provided by tunnel 130 between switches 103 and 105. Switch 103 may then facilitate one or more enhancement services that can ensure configuration consistency and efficiency among the devices of fabric 110.

During operation, upon detecting that tunnel 130 is operational, TNDP instance 172 on switch 103 can send a discovery packet 152 to peer switch 105. Similarly, instance 174 on switch 105 can send a discovery packet 154 to peer switch 103. TNDP instance 172 can then receive packet 154 from the peer switch. To send packet 152, switch 103 can encapsulate packet 152 with a tunnel header (e.g., a VXLAN header). The source and destination addresses of the tunnel header can be IP addresses 142 and 144, respectively. Switch 103 can then determine an egress port corresponding to IP address 144 and forward the encapsulated packet via the egress port.

Packets 152 and 154 can include a set of discovery information associated with switches 103 and 105, respectively. The set of discovery information associated with switch 103 can include a set of mandatory information and a set of optional information associated with switch 103. A respective piece of discovery information can be incorporated into the discovery packet based on TLV encoding. Upon receiving packet 154 from switch 105, TNDP instance 172 can parse a respective TLV field of packet 154 and obtain the information encoded in the TLV field.

TNDP instance 172 can then store the obtained information in association with an identifier, such as IP address 146 or MAC address 148, of switch 105 in an entry of a discovery table 160. An IP address column 162 of table 160 can store IP address 146, and a discovery information column 164 can store the information obtained from packet 154. In this way, TNDP instance 172 can obtain discovery information from a respective peer switch, such as switches 105 and VGS 106, from a corresponding tunnel. Switch 103 can then perform one or more enhancement operations, such as ensuring consistency and efficient provisioning, for switches 103 and 105 based on the discovery information.

Furthermore, TNDP instance 172 can provide the information from table 160 to a user via a local configuration interface of switch 103 or an external management tool through a communication channel. The user or the management tool can then perform the enhancement operations. In this way, In other words, TNDP instances 172 and 174 can facilitate a tunnel neighbor discovery process of individual tunnels. Consequently, TNDP instances 172 and 174 can ensure the discovery of tunnel neighbors associated with tunnel 130 without requiring the deployment of VPN 130.

The set of mandatory discovery information associated with switch 105 can include one or more of: a system name (or hostname) associated with switch 105, a source IP address allocated to switch 105, and an indicator indicating the end of packet 154. Furthermore, the set of optional discovery information can include one or more of: forwarding profile of switch 105, operational mode, interface tunnel description for tunnel 130, tunnel provisioning source for tunnel 130, the protocol for establishing routes in fabric 110 (e.g., eBGP and iBGP), configured layer-2 VNIs and layer-3 VNIs for tunnel 130, ARP configuration at switch 105, host routes associated with switch 105, management IP address of switch 105, tunnel bridging mode enabled/disabled, respective counts of MAC addresses, ARP table entries, and routes of switch 105, upstream connectivity information (e.g., MLAG or ROP) for switch 105, multicast bridging/routing enabled/disabled, spanning tree enabled/disabled, and the access port count.

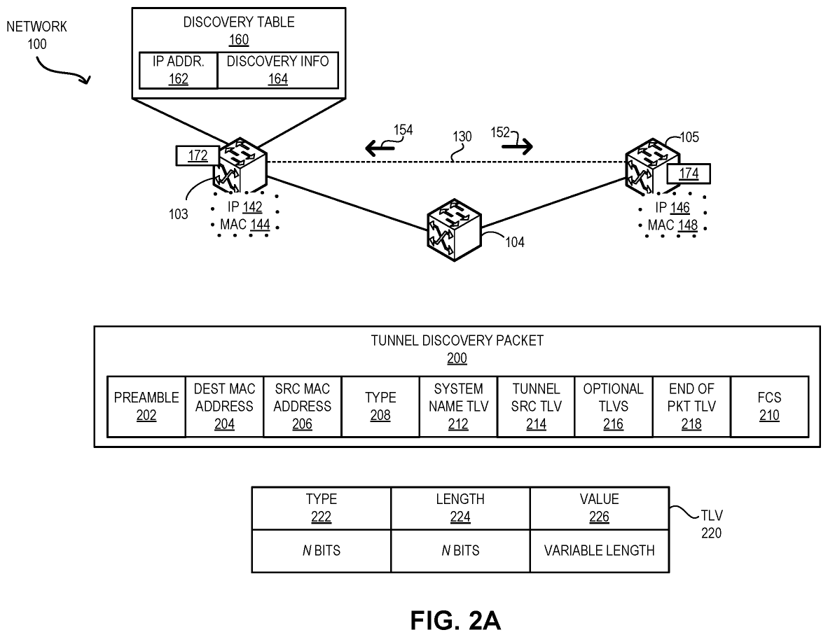

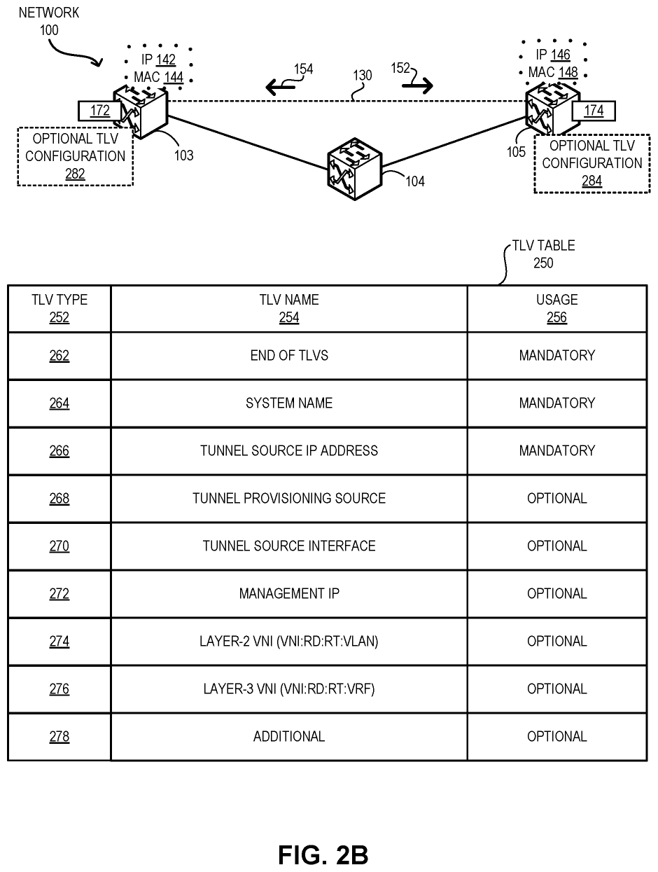

FIG. 2A illustrates an example of a discovery packet for facilitating tunnel neighbor discovery, in accordance with an aspect of the present application. A tunnel discovery packet 200, which can correspond to packets 152 and 154, can facilitate the discovery of a tunnel neighbor. Packet 200 is in a format recognizable by TNDP instances 172 and 174. Hence, a respective discovery packet issued by TNDP instances 172 and 174 can be consistent with the format of packet 200. Packet 200 can include a set of fields. Preamble 202 of packet 200 allows a receiving endpoint to determine the arrival of a new packet. Packet 200 can also include destination and source MAC addresses 204 and 206, respectively. For packet 154, values of MAC addresses 204 and 206 can correspond to MAC addresses 144 and 146, respectively.

A type 208 can indicate packet 200 to be a discovery packet. If packet 200 is an Ethernet frame, type 208 may correspond to an Ethertype. Type 208 can incorporate a predetermined value (e.g., Ethertype=0x88xx) to indicate that packet 200 is a discovery packet. A receiving endpoint may recognize packet 200 as a discovery packet based on type 208. Subsequently, packet 200 can include a set of TLV entries for a respective piece of discovery information. A respective TLV field 220 can include a type 222, a length 224, and a value 226. Each of type 222 and length 224 can be represented with N bits (e.g., 16 bits). Value 226 can have a variable length indicated by length 224.

System name TLV 212 can represent the name or hostname of the sending endpoint of the corresponding tunnel. Tunnel source TLV 214 can indicate the identifier of the sending endpoint of the tunnel. For packet 152, system name 212 can correspond to “switch 103,” which can be the hostname of switch 103. Tunnel source TLV 212 can then indicate IP address 142. Packet 200 can then include a set of optional TLVs 216 to accommodate optional discovery information. A TNDP instance may continue to parse packet 200 until reaching the end of packet TLV 218 is reached. In packet 200, TLVs 212, 214, and 218 can be mandatory since the corresponding information is essential for the tunnel neighbor discovery process. Packet 200 can then include a frame check sequence (FCS) 210, which can incorporate an error-detecting code for packet 200.

FIG. 2B illustrates examples of pieces of discovery information shared for tunnel neighbor discovery, in accordance with an aspect of the present application. A respective TNDP instance may maintain a TLV table 250 storing TLV information associated with different pieces of discovery information. It should be noted that table 250 represents a non-exhaustive list of the pieces of discovery information that may be included in a discovery packet. Table 250 can include a TLV type 252, TLV name 254, and a usage 256 for a respective TLV. Type 252 can be used to indicate or identify a type of TLV, which can correspond to a particular piece of discovery information, in a discovery packet. Name 254 can indicate a description of the piece of discovery information. Furthermore, usage 256 can indicate whether the piece of discovery information is optional for the discovery packet.

A respective TNDP instance on a switch can an optional TLV configuration for the switch. The optional TLV configuration can indicate which optional pieces of discovery information should be incorporated into a discovery message. For example, TNDP instances 172 and 174 can maintain optional TLV configuration 282 and 284, respectively. Optional TLV configuration 282 can be specific to switch 103 (i.e., can be distinct from optional TLV configuration 284) and can indicate which optional pieces of discovery information TNDP instance 172 should include in packet 152. Similarly, optional TLV configuration 284 can indicate which optional pieces of discovery information TNDP instance 174 should include in packet 154.

In table 250, a TLV type 262 can indicate the end of TLVs for a discovery packet. Since TLV type 262 is sufficient to indicate the end, the length of TLV type 262 (e.g., TLV 218 in FIG. 2A) may have a value of zero. TLV type 264 can indicate a system name, such as the hostname, of the sending endpoint. TLV type 266 can indicate the source IP address of the tunnel, which can be the IP address of the tunnel source at the sending endpoint. For packet 152, the source IP address of tunnel 130 can be IP address 142 of switch 103. On the other hand, for packet 154, the source IP address of tunnel 130 can be IP address 146 of switch 105. Usage 256 may indicate TLV types 262, 264, and 266 as mandatory. Usage 256 for the rest of the TLVs in table 250 can be optional.

TLV type 268 can indicate the tunnel provisioning source, which can indicate whether the tunnel is a static tunnel or generated based on a control plane. Furthermore, TLV type 270 can indicate the tunnel source interface, which can be a virtual interface at the tunnel source that can provide tunnel encapsulation for the packets transported over the tunnel. TLV type 272 can indicate a management IP address for the sending tunnel endpoint, which can be distinct from the IP address configured for the tunnel source. The management IP address can be used to facilitate management and configuration to the endpoint.

TLV type 274 can indicate the layer-2 VNIs for the tunnel. Such information can include a respective VNI, a route target (RT) that can be used for tagging routes for a VPN, a route distinguisher (RD) that can be appended to tenant prefixed to generate globally unique identifiers for the VPN, and the VLAN corresponding to the VNI. Moreover, TLV type 276 can indicate the layer-3 VNIs for the tunnel. Such information can include a respective VNI, an RT, an RD, and the virtual routing and forwarding (VRF) instance corresponding to the VNI. TLV type 278 may be used to indicate additional information associated with the sending endpoint, as described in conjunction with FIG. 1.

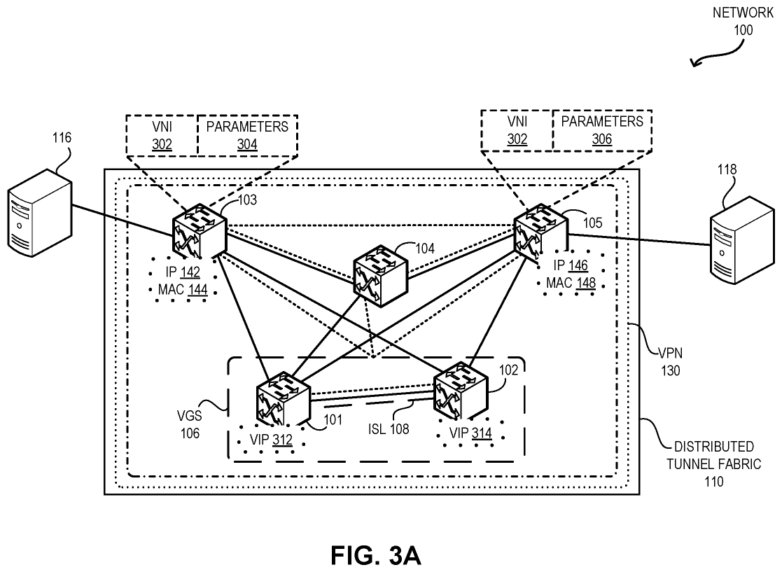

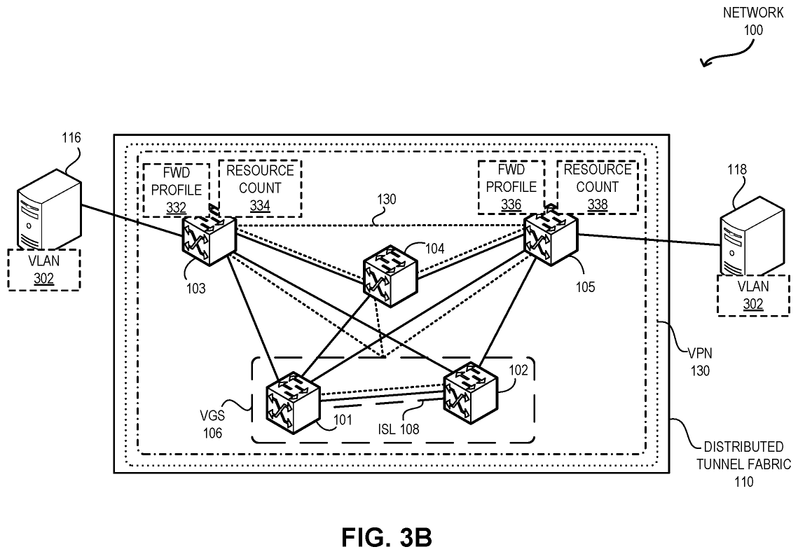

The discovery information can be used to facilitate enhanced services, such as configuration consistency and efficient provisioning based on the capabilities of a tunnel neighbor. FIG. 3A illustrates an example of determining configuration consistency based on tunnel neighbor discovery, in accordance with an aspect of the present application. The consistency can be related to a VPN or the configuration of a tunnel. For example, a VNI 302 can be configured with parameters 304 and 306 on switches 103 and 105, respectively. Based on tunnel neighbor discovery, switches 103 and 105 can determine that the configuration for VNI 302 is inconsistent.

Furthermore, a respective switch of VGS 106 should be associated with the same virtual IP address. However, due to misconfiguration, switches 101 and 103 can be allocated virtual IP addresses 312 and 314, respectively, for VGS 106. Based on tunnel neighbor discovery, switches 101 and 102 can determine that the configuration for the virtual IP address of VGS 106 is inconsistent. This allows a respective tunnel endpoint in fabric 100 to use the discovery information for identifying the misconfiguration and informing a user. Without the tunnel neighbor discovery, the user may need to execute multiple tunnel configuration and VPN configuration verification commands for a respective tunnel endpoint of fabric 100.

FIG. 3B illustrates an example of determining the capabilities of a tunnel neighbor, in accordance with an aspect of the present application. Typically, the capability configured for one endpoint of a tunnel should also be configured for the other endpoint. This allows a respective tunnel endpoint to determine the capabilities of the tunnel neighbor. The capability of a switch can indicate the capacity of a piece of resource. The capacity can correspond to the limitation of the hardware, software, and firmware of the resource of the switch. The capability of a switch can also indicate a set of operations and features supported by the switch.

For example, capability associated with forwarding profile 332 of switch 103 should also be present in forwarding profile 336 of switch 105. Similarly, resource count 334 of switch 103 should also be reflected in resource count 338 of switch 105. Examples of resource counts 334 and 338 can include, but are not limited to, host count, MAC address count, ARP resolution count, and access port count. This can also be used to determine whether a tunnel neighbor has oversubscribed any resources due to inefficient provisioning. In addition, a respective tunnel endpoint, such as switch 103 or 105, can identify the features associated with tunnel 130 and VPN 130 enabled on each endpoint. Since TNDP allows switch 103 to discover the capabilities of switch 105, switch 103 can adjust the provisioning for a piece of resource upon detecting oversubscription.

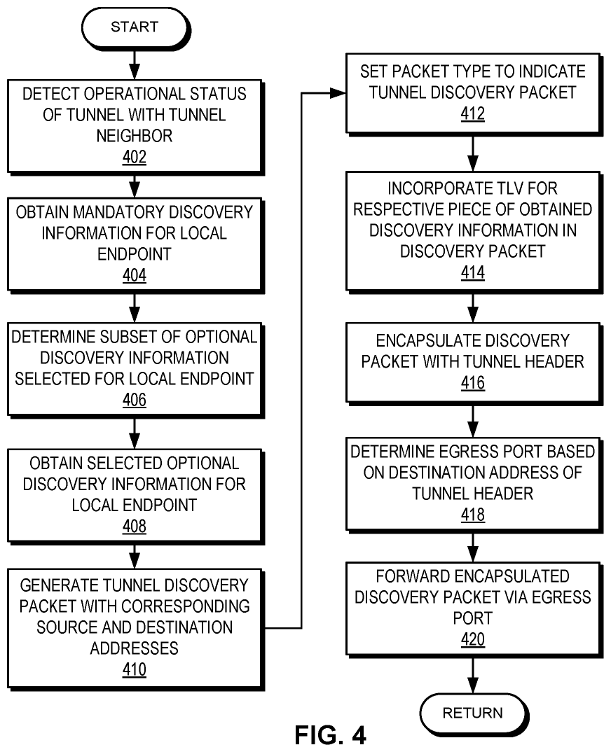

FIG. 4 presents a flowchart illustrating the process of a tunnel endpoint issuing a tunnel neighbor discovery packet, in accordance with an aspect of the present application. During operation, the TNDP instance of the tunnel endpoint can detect the operational status of a tunnel with a tunnel neighbor (i.e., a remote tunnel endpoint) (operation 402). The TNDP instance can then obtain the mandatory discovery information for the local endpoint (operation 404). The TNDP instance can also determine a subset of optional discovery information selected for the local endpoint (operation 406). The TNDP instance may determine the subset based on an optional TLV configuration associated with the local endpoint. The TNDP instance can then obtain the selected optional discovery information for the local endpoint (operation 408).

The TNDP instance can generate the tunnel discovery packet with corresponding source and destination addresses (operation 410). The addresses can be layer-2 addresses. The TNDP instance can set the packet type to indicate the tunnel discovery packet (operation 412) and incorporate the TLV for a respective piece of obtained discovery information in the discovery packet (operation 414). The tunnel endpoint can then encapsulate the discovery packet with a tunnel header (operation 416) and determine the egress port based on the destination address of the tunnel header (operation 418). Subsequently, the tunnel endpoint can forward the encapsulated discovery packet via the egress port (operation 420).

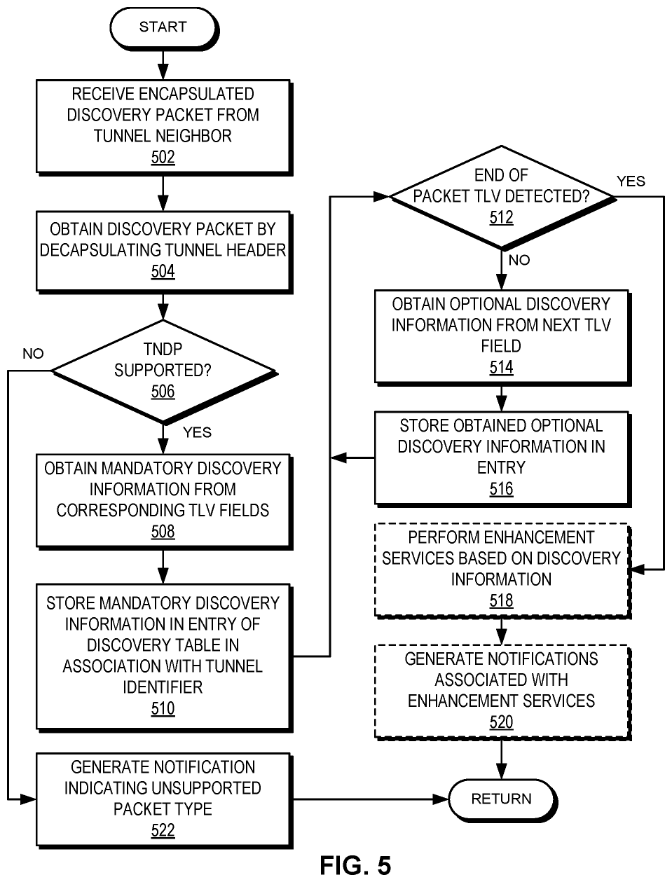

FIG. 5 presents a flowchart illustrating the process of a tunnel endpoint processing a tunnel neighbor discovery packet, in accordance with an aspect of the present application. During operation, the tunnel endpoint can receive an encapsulated discovery packet from a tunnel neighbor (operation 502) and obtain the discovery packet by decapsulating the tunnel header (operation 504). The tunnel endpoint can then determine whether the tunnel endpoint supports TNDP (operation 506). If TNDP is not supported, the tunnel endpoint can generate a notification indicating an unsupported packet type (operation 522).

On the other hand, if TNDP is supported, the TNDP instance of the tunnel endpoint can obtain the mandatory discovery information from the corresponding TLV fields of the discovery packet (operation 508). The TNDP instance can then store the mandatory discovery information in an entry of the discovery table in association with a tunnel identifier (operation 510). The tunnel identifier can include the IP addresses of the tunnel endpoints. In the example in FIG. 1, the tunnel identifier can include IP addresses 142 and 146. The TNDP instance can determine whether the end of packet TLV is detected in the discovery packet (operation 512).

If the end of packet TLV is not detected, the TNDP instance can obtain optional discovery information from the next TLV field (operation 514) and store the obtained optional discovery information in the entry (operation 516). The TNDP instance can then continue to determine whether the end of packet TLV has been detected in the discovery packet (operation 512). On the other hand, if the end of packet TLV is detected, the TNDP instance can, optionally, perform enhancement service based on discovery information (operation 518) and generate notifications associated with the enhancement services (operation 520) (denoted with dashed lines).

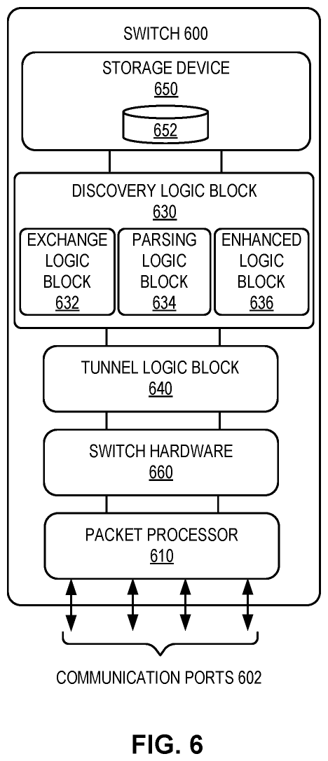

FIG. 6 illustrates an example of a switch with tunnel neighbor discovery support, in accordance with an aspect of the present application. In this example, a switch 600 can include a number of communication ports 602, a packet processor 610, and a storage device 650. Switch 600 can also include switch hardware 660 (e.g., processing hardware of switch 600, such as its application-specific integrated circuit (ASIC) chips), which includes information based on which switch 600 processes packets (e.g., determines output ports for packets). Packet processor 610 extracts and processes header information from the received packets. Packet processor 610 can identify a switch identifier (e.g., a MAC address and/or an IP address) associated with switch 600 in the header of a packet.

Communication ports 602 can include inter-switch communication channels for communication with other switches and/or user devices. The communication channels can be implemented via a regular communication port and based on any open or proprietary format. Communication ports 602 can include one or more Ethernet ports capable of receiving frames encapsulated in an Ethernet header. Communication ports 602 can also include one or more IP ports capable of receiving IP packets. An IP port is capable of receiving an IP packet and can be configured with an IP address. Packet processor 610 can process Ethernet frames and/or IP packets. A respective port of communication ports 602 may operate as an ingress port and/or an egress port.

Switch 600 can maintain a database 652 (e.g., in storage device 650). Database 652 can be a relational database and may run on one or more Database Management System (DBMS) instances. Database 652 can store information associated with routing, configuration, and interface of switch 600. Database 652 can also store a discovery table and a TLV table. Switch 600 can include a tunnel logic block 640 that can establish a tunnel with a remote switch, thereby allowing switch 600 to operate as a tunnel endpoint. Switch 600 can include a discovery logic block 630 that can facilitate a TNDP instance on switch 600. Discovery logic block 630 can include an exchange logic block 632, a parsing logic block 634, and an enhanced logical block 636.

Exchange logic block 632 can generate and send a discovery packet comprising local discovery information to a respective tunnel neighbor. Exchange logic block 632 can also receive a discovery packet from a respective remote tunnel neighbor. Parsing logic block 634 can parse a respective received discovery packet and obtain a respective piece of discovery information of the discovery packet. Parsing logic block 634 can then store and present the parsed discovery information. Enhanced logic block 636 can, optionally, perform enhancement operations for switch 600 based on the discovery information received from the tunnel neighbors.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method comprising:
establishing, by a first switch, a tunnel with a second switch in an overlay tunnel fabric that includes the first and second switches, wherein encapsulation of a packet sent via the tunnel is initiated and terminated between the first and second switches;
in response to establishing the tunnel, generating, at the first switch, a discovery packet comprising a first set of discovery information indicating configuration and capabilities of the first switch associated with the tunnel;
sending the discovery packet to the second switch via the tunnel prior to initiating payload data communication via the tunnel, thereby allowing the second switch to discover a peer endpoint of the tunnel;
receiving a second discovery packet from the second switch via the tunnel, wherein the second discovery packet comprises a second set of discovery information indicating configuration and capabilities of the second switch associated with the tunnel; and
storing the second set of discovery information in an entry of a data structure, wherein a respective entry of the data structure comprises information associated with a remote tunnel endpoint of the overlay tunnel fabric.

2. The method of claim 1, wherein a respective piece of discovery information in the first set of discovery information is encoded as a type-length-value (TLV) field in the first discovery packet.

3. The method of claim 2, wherein a respective discovery packet includes respective TLV fields for a system name, a source address of the tunnel, and an end of packet indicator.

4. The method of claim 3, wherein a respective discovery packet further includes respective TLV fields for one or more of: a provisioning source of the tunnel, a source interface of the tunnel, and a management address of a source of the discovery packet, a first set of information associated with a layer-2 virtual network identifier (VNI) configured for the tunnel, and a second set of information associated with a layer-3 VNI configured for the tunnel.

5. The method of claim 1, further comprising selecting a subset of optional discovery information associated with the first switch for incorporating into the first set of discovery information.

6. The method of claim 1, further comprising determining that the second discovery packet is for tunnel neighbor discovery based on a packet type of the second discovery packet.

7. The method of claim 1, further comprising determining configuration consistency for the tunnel based on the first and second sets of discovery information.

8. The method of claim 1, further comprising determining capability of the second switch based on the second set of discovery information, wherein the capability includes capacities and supported features of the second switch.

9. The method of claim 8, further comprising determining whether the second switch is inefficiently provisioned by comparing respective capabilities of the first and second switches.

10. A non-transitory computer-readable storage medium storing instructions that when executed by a computer cause the computer to perform a method, the method comprising:
establishing, by a first switch, a tunnel with a second switch in an overlay tunnel fabric that includes the first and second switches, wherein encapsulation of a packet sent via the tunnel is initiated and terminated between the first and second switches;
in response to establishing the tunnel, generating, at the first switch, a discovery packet comprising a first set of discovery information indicating configuration and capabilities of the first switch associated with the tunnel;
sending the discovery packet to the second switch via the tunnel prior to initiating payload data communication via the tunnel, thereby allowing the second switch to discover a peer endpoint of the tunnel;
receiving a second discovery packet from the second switch via the tunnel, wherein the second discovery packet comprises a second set of discovery information indicating configuration and capabilities of the second switch associated with the tunnel; and
storing the second set of discovery information in an entry of a data structure, wherein a respective entry of the data structure comprises information associated with a remote tunnel endpoint of the overlay tunnel fabric.

11. The non-transitory computer-readable storage medium of claim 10, wherein a respective piece of discovery information in the first set of discovery information is encoded as a type-length-value (TLV) field in the first discovery packet.

12. The non-transitory computer-readable storage medium of claim 11, wherein a respective discovery packet includes respective TLV fields for a system name, a source address of the tunnel, and an end of packet indicator.

13. The non-transitory computer-readable storage medium of claim 12, wherein a respective discovery packet further includes respective TLV fields for one or more of: a provisioning source of the tunnel, a source interface of the tunnel, and a management address of a source of the discovery packet, a first set of information associated with a layer-2 virtual network identifier (VNI) configured for the tunnel, and a second set of information associated with a layer-3 VNI configured for the tunnel.

14. The non-transitory computer-readable storage medium of claim 10, wherein the method further comprises selecting a subset of optional discovery information associated with the first switch for incorporating into the first set of discovery information.

15. The non-transitory computer-readable storage medium of claim 10, wherein the method further comprises determining that the second discovery packet is for tunnel neighbor discovery based on a packet type of the second discovery packet.

16. The non-transitory computer-readable storage medium of claim 10, wherein the method further comprises determining configuration consistency for the tunnel based on the first and second sets of discovery information.

17. The non-transitory computer-readable storage medium of claim 10, wherein the method further comprises determining capability of the second switch based on the second set of discovery information, wherein the capability includes capacities and supported features of the second switch.

18. The non-transitory computer-readable storage medium of claim 17, wherein the method further comprises determining whether the second switch is inefficiently provisioned by comparing respective capabilities of the first and second switches.

19. A computer system, comprising:
a processor;
a memory device;
a tunnel logic block to establish, by the computer system, a tunnel with a second computer system in an overlay tunnel fabric that includes the first and second computer systems, wherein encapsulation of a packet sent via the tunnel is initiated and terminated between the first and second computer systems;
an exchange logic block to:
in response to establishing the tunnel, generate, at the computer system, a discovery packet comprising a first set of discovery information indicating configuration and capabilities of the computer system associated with the tunnel;
send the discovery packet to the second computer system via the tunnel prior to initiating payload data communication via the tunnel, thereby allowing the second computer system to discover a peer endpoint of the tunnel; and
receive a second discovery packet from the computer system via the tunnel, wherein the second discovery packet comprises a second set of discovery information indicating configuration and capabilities of the computer system associated with the tunnel; and
a parsing logic block to store the second set of discovery information in an entry of a data structure, wherein a respective entry of the data structure comprises information associated with a remote tunnel endpoint of the overlay tunnel fabric.

20. The computer system of claim 19, wherein a respective piece of discovery information in the first set of discovery information is encoded as a type-length-value (TLV) field in the first discovery packet.
